(19) United States
(12) Patent Application Publication
(10) Pub. No.: US 2025/0034717 A1
(43) Pub. Date: Jan. 30, 2025

(54) ELECTROLESS NI-P PLATING FILM FOR SLIDING MEMBER AND MANUFACTURING METHOD THEREFOR

(71) Applicant: SANDEN CORPORATION, Gunma (JP)

(72) Inventors: Koki KAKINUMA, Gunma (JP); Hiromitsu SHISHIDO, Gunma (JP); Takuma KITAHARA, Gunma (JP)

(21) Appl. No.: 18/715,853

(22) PCT Filed: Nov. 25, 2022
(86) PCT No.: PCT/JP2022/043446

§ 371 Date: Jun. 3, 2024

(30) Foreign Application Priority Data
Dec. 15, 2021 (JP) 2021-203142

(51) Int. Cl. C23C 18/36; C23C 18/16

(52) U.S. Cl. CPC C23C 18/36; C23C 18/1696

(57) ABSTRACT

The invention according to the present application addresses the problem of providing: an electroless Ni—P plating film for sliding members which provides good lubricity under a poor lubrication environment and improves the wear resistance of a sliding member and an electroless Ni—P plating film disposed on a surface of the sliding member and the seizure resistance between sliding members while maintaining the dimensional stability and strength of the sliding member; and a method for producing the same. In order to address this problem, the electroless Ni—P plating film according to the present application adopts an electroless Ni—P plating film for sliding members which has a minute irregularity shape of a predetermined size on the surface and has a Vickers hardness of 600 HV or more, and a method for producing the same.

### TECHNICAL FIELD

The present application relates to an electroless Ni—P plating film for sliding members which has minute irregularities on the surface, and a method for producing the same.

### BACKGROUND ART

As a compressor which is a main part of a vehicle air conditioner, a vane compressor, a scroll compressor, and the like are known. These compressors include a sliding member inside, and, for example, the scroll compressor is constituted by spiral members of a fixed scroll and an orbiting scroll (each corresponds to a sliding member) made of aluminum, an aluminum alloy, or the like, and a metal member that covers and holds the spiral members from the outside. Such sliding members slide with respect to each other when the compressor is operated, and the surfaces of the members are worn. Therefore, a hard electroless Ni—P plating film or the like is applied on at least one of the surfaces (for example, the surface of the fixed scroll or the orbiting scroll, or the surfaces of the fixed scroll and the orbiting scroll).

However, this electroless Ni—P plating film highly tends to have a relatively smooth and uniform film thickness without generating irregularities on the surface. Therefore, even if lubricating oil or the like is applied on the film surface, the retention of the oil film is low, and there are problems such as abnormal wear of the electroless Ni—P plating film and occurrence of the seizure between the sliding members when the compressor is continuously operated and brought under a poor lubrication environment. Further, a heat treatment at 300° C. to 400° C. is known as a method for further increasing the hardness of the electroless Ni—P plating film. However, when the material is aluminum, an aluminum alloy, or the like, such as the fixed scroll and the orbiting scroll, a heat treatment at a temperature exceeding 200° C. is not practical due to dimensional change and strength reduction of the members.

In order to improve the wear resistance and toughness of such an electroless Ni—P plating film for sliding members, the following method has been proposed. Patent Literature 1 adopts a “sliding member for compressors, including: a base material made of an aluminum alloy; and an electroless nickel plating layer formed on a surface of the base material, the electroless nickel plating layer containing a crystallite of Ni of a predetermined size and 1.0% by mass or more and 2.0% by mass or less of phosphorus and being a non-heat-treated layer”.

### CITATION LIST

### Patent Literature

Patent Literature 1: JP-A-2019-60259

### SUMMARY OF INVENTION

### Problems to be Solved by Invention

However, even with this sliding member of Patent Literature 1, the above-described problem of the seizure between the sliding members may still occur, and market requirements are not sufficiently satisfied.

As can be understood from the above, it has been required among those skilled in the art to provide an electroless Ni—P plating film for sliding members which provides good lubricity under a poor lubrication environment and improves the wear resistance of a sliding member and an electroless Ni—P plating film disposed on a surface of the sliding member and the seizure resistance between sliding members while maintaining dimensional stability and strength of a sliding member.

### Solution to Problems

Therefore, as a result of intensive research, the inventor of the present application has conceived the following invention and has solved the above-described problems.

### A. Electroless Ni—P Plating Film According to Present Application

The electroless Ni—P plating film according to the present application is for sliding members and has, on the surface thereof, a minute irregularity shape having a maximum height (Sz) of 0.5 μm or more, a core-part spatial volume (Vvc) of 2000 μm³ or more, a reduced-valley-part spatial volume (Vvv) of 300 μm³ or more, a root mean square slope (Sdq) of 40 μm/mm or more, and an arithmetic mean peak curvature (Spc) of 300 mm⁻¹ or more, in which when an oil component is applied on a surface of the electroless Ni—P plating film, the minute irregularities enhance retention of an oil film formed of the oil component, and when the electroless Ni—P plating film is applied only on a surface of one sliding member, and a plating film as a solid lubricating component is applied on a surface of the other sliding member, the minute irregularities enhance transferability of the solid lubricating component to the surface of the electroless Ni—P plating film; and the electroless Ni—P plating film has a Vickers hardness of 600 HV or more.

The electroless Ni—P plating film according to the present application preferably has a phosphorus content of 2% by mass to 9% by mass.

### B. Method for Producing Electroless Ni—P Plating Film According to Present Application

The method for producing the electroless Ni—P plating film according to the present application is a method for obtaining an electroless Ni—P plating film for sliding members and includes the following steps 1 to 3:
step 1: preparing an electroless Ni—P plating solution for continuous use while performing partial initial make-up of an electrolytic bath and for obtaining an electroless Ni—P plating film having a phosphorus content of 2% by mass to 9% by mass;
step 2: performing an electroless plating treatment to a member to be plated using the electroless Ni—P plating solution prepared in step 1 to obtain an electroless Ni—P plating film having a minute irregularity shape on the surface and a phosphorus content of 2% by mass to 9% by mass; and
step 3: performing a heat treatment to the electroless Ni—P plating film obtained in step 2 at 140° C. to 200° C. for 0.5 hour to 3 hours in the air to obtain an electroless Ni—P plating film that more strengthens a metal bond between Al—Ni to enhance adhesion between a surface of the member to be plated and the electroless Ni—P plating film when a material of the member to be plated is aluminum or an aluminum alloy and that has a minute irregularity shape on the surface and has a Vickers hardness of 600 HV or more.

The partial initial make-up of an electrolytic bath in step 1 is preferably performed by mixing an unused new solution and an old solution having been used for an electroless plating treatment at a ratio of 50% by mass to 80% by mass of the new solution and 20% by mass to 50% by mass of the old solution when a total of the new solution and the old solution is 100% by mass.

### Effects of Invention

According to the invention of the present application, it is possible to provide an electroless Ni—P plating film for sliding members which provides good lubricity under a poor lubrication environment and improves the wear resistance of a sliding member and an electroless Ni—P plating film disposed on a surface of the sliding member and the seizure resistance between sliding members while maintaining the dimensional stability and strength of a sliding member, and a method for producing the same.

### BRIEF DESCRIPTION OF DRAWINGS

FIGS. 1(A) and 1(B) are optical microscope images of electroless Ni—P plating films of an example and a comparative example.

### DESCRIPTION OF EMBODIMENTS

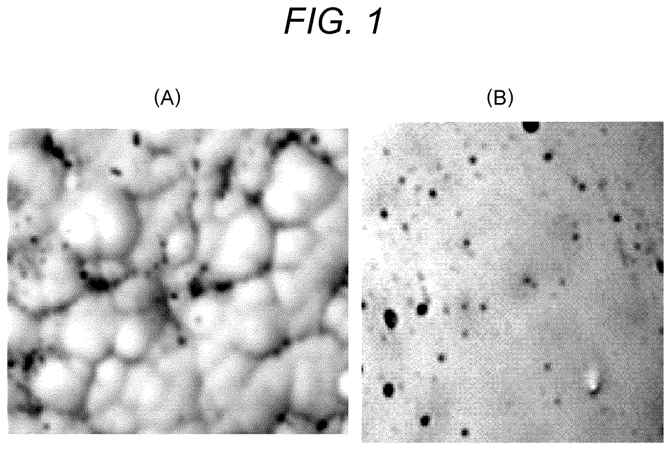

Hereinafter, an embodiment of the electroless Ni—P plating film for sliding members and the method for producing the same according to the present application will be described with reference to FIG. 1.

### A. Electroless Ni—P Plating Film According to Present Application

The electroless Ni—P plating film according to the present application is for sliding members, has minute irregularities of a predetermined size on the surface, and has a Vickers hardness of 600 HV or more. When lubricating oil or the like is applied on the film surface, retention of the oil film is enhanced, and good lubricity under a poor lubrication environment is provided, because the film has the surface irregularities. In addition, even when the electroless Ni—P plating film is applied only on a surface of one sliding member, and a plating film such as electroless Sn plating as a solid lubricating component is applied on a surface of the other sliding member, the transferability of the solid lubricating component (for example, Sn, an Sn alloy, or the like constituting an electroless Sn plating film) to the surface of the electroless Ni—P plating film is enhanced, and good lubricity under a poor lubrication environment is provided. As a result, the wear resistance of a sliding member and an electroless Ni—P plating film disposed on a surface of the sliding member is enhanced, which improves the seizure resistance between sliding members. Further, when the Vickers hardness of the film is 600 HV or more, the wear resistance of a sliding member and an electroless Ni—P plating film disposed on a surface of the sliding member and the seizure resistance between sliding members become good.

### A-1. Composition of Electroless Ni—P Plating Film

The electroless Ni—P plating film according to the present application has a phosphorus (P) content of 2% by mass to 9% by mass. When the phosphorus content in the film is less than 2% by mass, adhesion of the film to a surface of a member to be plated tends to decrease, which is not preferable. On the other hand, when the phosphorus content exceeds 9% by mass, the nickel content decreases, and the hardness of the electroless Ni—P plating film tends to decrease, which is not preferable. Further, this electroless Ni—P plating film more preferably has a phosphorus content of 4% by mass to 9% by mass in order to further enhance the adhesion to a member to be plated.

### A-2. Surface Shape and Characteristics of Electroless Ni—P Plating Film

The electroless Ni—P plating film according to the present application has, on the surface, a minute irregularity shape having a maximum height (Sz) of 0.5 μm or more, a core-part spatial volume (Vvc) of 2000 μm³ or more, a reduced-valley-part spatial volume (Vvv) of 300 μm³ or more, a root mean square slope (Sdq) of 40 μm/mm or more, and an arithmetic mean peak curvature (Spc) of 300 mm⁻¹ or more. Here, the maximum height, the core-part spatial volume, the reduced-valley-part spatial volume, the root mean square slope, and the arithmetic mean peak curvature are parameters indicating surface roughness defined in ISO25178. When any one or more of the maximum height, the core-part spatial volume, the reduced-valley-part spatial volume, the root mean square slope, and the arithmetic mean peak curvature is less than each of the above-described values, the minute irregularities on the film surface become too small. Further, when lubricating oil or the like is applied on the surface of the electroless Ni—P plating film, the retention of an oil film formed of the oil component tends to decrease, leading to deterioration of lubricity under a poor lubrication environment. In addition, when the film is applied only on a surface of one sliding member, and a plating film such as electroless Sn plating as a solid lubricating component is applied on a surface of the other sliding member (for example, when in a scroll compressor, the electroless Ni—P film is applied only on a surface of an “orbiting scroll”, and normal electroless Sn plating or the like is applied on a surface of a “fixed scroll”), the solid lubricating component is less likely to transfer to the surface irregularities of the electroless Ni—P plating film, so that lubricity under a poor lubrication environment tends to decrease. As a result, the wear resistance of a sliding member and an electroless Ni—P plating film disposed on a surface of the sliding member and the seizure resistance between sliding members tend to decrease, which is not preferable. Note that the upper limit of each of these parameters is not particularly limited. However, excessively large irregularities of the surface of the electroless Ni—P plating film is not preferable, because the irregularities exceed the surface roughness of a base material, for sliding members, itself made of aluminum, an aluminum alloy, or the like, and the appearance of the product tends to be poor. In addition, when, for example, a compressor incorporating a sliding member is operated at a rotation speed of, for example, 5000 rpm or more, the wear amount of the electroless Ni—P plating film applied on the surface of the sliding member tends to increase, which is not preferable. Further, in an aspect in which the film is applied only on a surface of one sliding member, the film may damage a surface of the other sliding member on which the film is not applied (for example, a surface of a “fixed scroll” in a scroll compressor when the electroless Ni—P plating film is applied only on a surface of an “orbiting scroll”), which is not preferable. Therefore, the size of the minute irregularities on a surface of the electroless Ni—P plating film is preferably a maximum height (Sz) of 2.0 μm or less, a core-part spatial volume (Vvc) of 10000 μm³ or less, a reduced-valley-part spatial volume (Vvv) of 2000 μm³ or less, a root mean square slope (Sdq) of 200 μm/mm or less, and an arithmetic mean peak curvature (Spc) of 3000 mm⁻¹ or less. Further, the size of the minute irregularities on a surface of the electroless Ni—P plating film is more preferably a maximum height (Sz) of 1.5 μm or less, a core-part spatial volume (Vvc) of 7000 μm³ or less, a reduced-valley-part spatial volume (Vvv) of 1500 μm³ or less, a root mean square slope (Sdq) of 150 μm/mm or less, and an arithmetic mean peak curvature (Spc) of 2000 mm⁻¹ or less, in order to further reduce the wear amount of the film and suppress the damage to a surface of the other sliding member on which the film is not applied.

The electroless Ni—P plating film according to the present application has a Vickers hardness of 600 HV or more at test load HV 0.03 defined in JIS-Z224-1. When the Vickers hardness is less than 600 HV, the wear resistance of a sliding member and an electroless Ni—P plating film disposed on a surface of the sliding member and the seizure resistance between sliding members tend to decrease, which is not preferable. Here, the upper limit of the Vickers hardness of the film is not particularly limited. However, when the Vickers hardness of the electroless Ni—P plating film is too large, the film in an aspect in which the film is applied only on a surface of one sliding member may damage a surface of the other sliding member on which the film is not applied (for example, a surface of a “fixed scroll” in a scroll compressor when the electroless Ni—P plating film is applied only on a surface of an “orbiting scroll”) when, for example, a compressor incorporating a sliding member is operated, which is not preferable. Therefore, the electroless Ni—P plating film preferably has a Vickers hardness of 800 HV or less at test load HV 0.03 defined in JIS-Z224-1.

### B. Method for Producing Electroless Ni—P Plating Film According to Present Application

The method for producing the electroless Ni—P plating film according to the present application is a method for obtaining an electroless Ni—P plating film for sliding members and includes the following step 1 to step 3.

Step 1: Preparing an electroless Ni—P plating solution for continuous use while performing partial initial make-up of an electrolytic bath and for obtaining an electroless Ni—P plating film having a phosphorus content of 2% by mass to 9% by mass.

In this step 1, an “electroless Ni—P plating solution (for example, SEK-670 manufactured by Japan Kanigen Co., Ltd., and the like)” for obtaining an electroless Ni—P plating film having a phosphorus content of 2% by mass to 9% by mass is firstly prepared. A new solution of this electroless Ni—P plating solution and an old solution having been used for an electroless plating treatment are mixed at a predetermined ratio to adjust an electroless Ni—P plating solution subjected to partial initial make-up of an electrolytic bath. Here, the old solution of the electroless Ni—P plating solution refers to a used solution obtained by subjecting a substrate such as aluminum to an electroless plating treatment at a predetermined bath ratio and bath temperature.

In addition, as a result of analyzing components contained in the above-described “electroless Ni—P plating solution” from “immediately after partial initial make-up of an electrolytic bath” to “immediately before replacing an electroless plating solution” after use in a usual method by capillary electrophoresis or the like, it is understood that when the plating solution contains a hypophosphite (for example, sodium hypophosphite) as a general reducing agent, the concentration of a phosphite as the by-product tends to increase. Therefore, it is also considered that in the above-described “electroless Ni—P plating solution for continuous use while performing partial initial make-up of an electrolytic bath”, a state in which a trace amount of a phosphite which does not function as a reducing agent is mixed in the plating solution is maintained, phosphorus derived from the phosphite is segregated in the film to serve as a nucleus of film growth at the time of deposition of a metal component, and minute irregularities are formed on a surface of the film.

Then, the partial initial make-up of an electrolytic bath in step 1 is preferably performed by mixing an unused new solution and an old solution having been used for an electroless plating treatment at a ratio of 50% by mass to 80% by mass of the new solution and 20% by mass to 50% by mass of the old solution when a total of the new solution and the old solution is 100% by mass. When in this mixing ratio, the amount of the new solution is less than 50% by mass, or the amount of the old solution is more than 50% by mass, the reaction rate of electroless plating (the deposition rate of a metal component for forming a film) decreases, and an electroless Ni—P film having good appearance tends not to be obtained, which is not preferable. On the other hand, when the amount of the old solution is less than 20% by mass, or the amount of the new solution is more than 80% by mass, minute irregularities of a predetermined size are not formed on a surface of the film when an electroless plating treatment is performed. Further, when lubricating oil or the like is applied on the surface of the electroless Ni—P plating film, the retention of an oil film formed of the oil component tends to decrease, leading to deterioration of lubricity under a poor lubrication environment. In addition, when the film is applied only on a surface of one sliding member, and a plating film such as electroless Sn plating as a solid lubricating component is applied on a surface of the other sliding member (for example, when in a scroll compressor, the electroless Ni—P plating film is applied only on a surface of an “orbiting scroll”, and normal electroless Sn plating or the like is applied on a surface of a “fixed scroll”), the solid lubricating component is less likely to transfer to the surface irregularities of the electroless Ni—P plating film, so that lubricity under a poor lubrication environment tends to decrease. As a result, the wear resistance of a sliding member and an electroless Ni—P plating film disposed on a surface of the sliding member and the seizure resistance between sliding members tend to decrease, which is not preferable.

Step 2: Performing an electroless plating treatment to a member to be plated using the electroless Ni—P plating solution prepared in step 1 to obtain an electroless Ni—P plating film having a minute irregularity shape on a surface and a phosphorus content of 2% by mass to 9% by mass.

In this step 2, a known method is used, and there is no particular limitation. For example, while maintaining the “electroless Ni—P plating solution for continuous use while performing partial initial make-up of an electrolytic bath” obtained in step 1 at a predetermined temperature (for example, 88° C. to 94° C.), an object to be plated (for example, a sliding member made of aluminum, an aluminum alloy, or the like) can be immersed for a predetermined time, washed with water, and dried to obtain an electroless Ni—P plating film having a minute irregularity shape on a surface and a phosphorus content of 2% by mass to 9% by mass. Note that the object to be plated is also preferably subjected to degreasing, washing, or the like by a known method as a pretreatment of electroless Ni—P plating.

Step 3: Performing a heat treatment to the electroless Ni—P plating film obtained in step 2 at 140° C. to 200° C. for 0.5 hour to 3 hours in the air to obtain an electroless Ni—P plating film that more strengthens a metal bond between Al—Ni to enhance adhesion between a surface of the member to be plated and the electroless Ni—P plating film when the material of the member to be plated is aluminum or an aluminum alloy and that has a minute irregularity shape on a surface and a Vickers hardness of 600 HV or more.

In this step 3, the electroless Ni—P plating film obtained in step 2 is heat-treated under predetermined conditions to enhance the hardness of the film. Here, when the temperature of the heat treatment is lower than 140° C., or the heat treatment time is shorter than 0.5 hour, a metal bond between Al—Ni is not sufficiently generated when the material of the member to be plated is aluminum or an aluminum alloy, and the adhesion between the surface of the member to be plated and the electroless Ni—P plating film tends not to be enhanced. In addition, the hardness of the electroless Ni—P plating film also tends not to be enhanced. As a result, the wear resistance of a sliding member and an electroless Ni—P plating film disposed on a surface of the sliding member and the seizure resistance between sliding members tend to decrease, which is not preferable. On the other hand, when the temperature of the heat treatment is higher than 200° C., or the time of the heat treatment is longer than 3 hours, there is a tendency that the dimension of a sliding member made of aluminum, an aluminum alloy, or the like changes, or the strength of the member decreases, which is not preferable.

Hereinafter, an example according to the present application will be presented and described more specifically. Note that the technical idea of the invention according to the present application is not to be construed as being limited to the description of the example and the like described below.

### EXAMPLES

### (Preparation of Electroless Ni—P Plating Solution Subjected to Partial Initial Make-Up of Electrolytic Bath)

In an example, an electroless Ni—P plating solution (SEK-670 manufactured by Japan Kanigen Co., Ltd.) in which the concentration of nickel sulfate was adjusted to 24.7 g/L was firstly prepared (corresponding to the “unused electroless Ni—P plating solution (new solution)”). In this electroless Ni—P plating solution, an electroless Ni—P plating treatment was performed to an aluminum substrate for 1 hour under the conditions of a pH of 4.5 and a bath temperature of 90° C. to obtain a “used electroless Ni—P plating solution (old solution)”. Then, this “used electroless Ni—P plating solution (old solution)” and the above-described “unused electroless Ni—P plating solution (new solution)” were mixed at a ratio of 70% by mass of the new solution and 30% by mass of the old solution when a total of the new solution and the old solution was 100% by mass, thereby obtaining an “electroless Ni—P plating solution obtained by partial initial make-up of an electrolytic bath”.

### (Evaluation of Electroless Ni—P Plating Film)

Next, an “orbiting scroll made of aluminum” as a member of a scroll compressor was immersed in the “electroless Ni—P plating solution obtained by partial initial make-up of an electrolytic bath” prepared by the above-described method under the conditions of a pH of 4.5 and a bath temperature of 90° C. for 1 hour and 30 minutes to perform an electroless Ni—P plating treatment, and thereafter washed with water, dried, and heat-treated at 150° C. for 1 hour in the air to obtain an “orbiting scroll including an electroless Ni—P plating film having minute irregularities on a surface”. Here, the film thickness of the electroless Ni—P plating film was measured by a fluorescent X-ray film thickness meter to be 25 μm.

For this “electroless Ni—P plating film having minute irregularities on a surface”, a phosphorus content measured by an EDS-equipped scanning electron microscope (JSM-IT300 manufactured by JEOL Ltd.), a size of the surface irregularities measured by a laser microscope equipped with a white interferometer (VK—X3000 manufactured by KEYENCE CORPORATION), and a Vickers hardness at HV 0.03 are shown in Table 1. In addition, an optical microscope image of the film surface measured by the laser microscope equipped with a white interferometer is shown in FIG. 1(A).

Subsequently, a scroll compressor was produced using the “orbiting scroll including an electroless Ni—P plating film having minute irregularities on a surface” and a “fixed scroll not having the film”, and the scroll compressor was operated to evaluate the seizure resistance of the sliding members and the wear amount of the electroless Ni—P plating film. The evaluation results are shown in Table 1.

Note that in Table 1, “Seizure resistance is Good” was described when a cycle test of an ON/OFF operation in which the scroll compressor produced by the above-described method was operated at a rotation speed of 8000 rpm, and thereafter the rotation was stopped and started again was performed for 6000 cycles, and thereafter the compressor could be normally operated, and “Seizure resistance is Poor” was described when the orbiting scroll and the fixed scroll are fused to each other by frictional heat, and the compressor did not act normally. Further, in Table 1, the result of measuring the wear amount of the film thickness of the electroless Ni—P plating film applied on the surface of the orbiting scroll by the same method as in the film thickness measurement described above after 6000 cycles of the cycle test was described as “Wear amount (μm)”.

### Comparative Examples

A comparative example is different from an example only in that an electroless Ni—P plating film was formed on the surface of the orbiting scroll using only the “unused electroless Ni—P plating solution (new solution)”. Therefore, the description of the test and evaluation method is omitted. The evaluation result and optical microscope observation image of this comparative example are shown in Table 1 and FIG. 1(B), respectively.

TABLE 1

| | Phosphorus | Size of irregularities of film surface | | | | | Vickers | | Wear amount |
|---|---|---|---|---|---|---|---|---|---|
| | content in film | Sz | Vvc | Vvv | Sdq | Spc | hardness | Seizure | of film |
| | (% by mass) | (μm) | (μm³) | (μm³) | (μm/mm) | (mm⁻¹) | (HV) | resistance | (μm) |
| Example | 5.8 | 0.61 | 2073 | 351 | 43.8 | 513.2 | 623 | Good | 3.3 |
| Comparative | 7.1 | 0.37 | 1359 | 222 | 18.2 | 37.5 | 549 | Poor | 25 |
| Example | | | | | | | | | |

### Comparison Between Example and Comparative Example

The results shown in Table 1 and FIG. 1(A) described above demonstrate that in an example in which a minute irregularity shape having a maximum height (Sz) of 0.5 μm or more, a core-part spatial volume (Vvc) of 2000 μm³ or more, a reduced-valley-part spatial volume (Vvv) of 300 μm³ or more, a root mean square slope (Sdq) of 40 μm/mm or more, and an arithmetic mean peak curvature (Spc) of 300 mm⁻¹ or more is provided on a surface, and the film has a Vickers hardness of 600 HV or more, seizure between sliding members did not occur, and the wear amount of the electroless Ni—P plating film applied on the surface of the sliding member was also small, even after the scroll compressor was rotated for 6000 cycles. On the other hand, Table 1 and FIG. 1(B) described above demonstrate that in an comparative example in which a relatively flat surface is provided with surface irregularities having a size of less than each of the above-described values, and the film has a Vickers hardness of less than 600 HV, seizure between sliding members occurred, and a normal action was disabled, after the scroll compressor was rotated for 6000 cycles, and the electroless Ni—P plating film applied on the surface of the sliding member completely disappeared due to the seizure.

### INDUSTRIAL APPLICABILITY

The electroless Ni—P plating film and the method for producing the same according to the present application can be used as a metal film to be applied on a surface of a sliding member in a compressor which is a main part of a vehicle air conditioner and a method for producing the same. In particular, the electroless Ni—P plating film and the method for producing the same according to the present application can be suitably used when the material of the sliding member is aluminum or an aluminum alloy.

1. An electroless Ni—P plating film for sliding members, comprising
a minute irregularity shape on a surface, the minute irregularity shape having a maximum height (Sz) of 0.5 μm or more, a core-part spatial volume (Vvc) of 2000 μm³ or more, a reduced-valley-part spatial volume (Vvv) of 300 μm³ or more, a root mean square slope (Sdq) of 40 μm/mm or more, and an arithmetic mean peak curvature (Spc) of 300 mm⁻¹ or more, wherein
when an oil component is applied on a surface of the electroless Ni—P plating film, the minute irregularities enhance retention of an oil film formed of the oil component, when the electroless Ni—P plating film is applied only on a surface of one sliding member, and a plating film as a solid lubricating component is applied on a surface of the other sliding member, the minute irregularities enhance transferability of the solid lubricating component to the surface of the electroless Ni—P plating film, and
the electroless Ni—P plating film has a Vickers hardness of 600 HV or more.

2. The electroless Ni—P plating film according to claim 1, having a phosphorus content of 2% by mass to 9% by mass.

3. A method for producing the electroless Ni—P plating film according to claim 1, comprising step 1 to step 3 below:
step 1: preparing an electroless Ni—P plating solution for continuous use while performing partial initial make-up of an electrolytic bath and for obtaining an electroless Ni—P plating film having a phosphorus content of 2% by mass to 9% by mass;
step 2: performing an electroless plating treatment to a member to be plated using the electroless Ni—P plating solution prepared in step 1 to obtain an electroless Ni—P plating film having a minute irregularity shape on a surface and a phosphorus content of 2% by mass to 9% by mass; and
step 3: performing a heat treatment to the electroless Ni—P plating film obtained in step 2 at 140° C. to 200° C. for 0.5 hour to 3 hours in an air to obtain an electroless Ni—P plating film that more strengthens a metal bond between Al—Ni to enhance adhesion between a surface of the member to be plated and the electroless Ni—P plating film when a material of the member to be plated is aluminum or an aluminum alloy and that has a minute irregularity shape on a surface and has a Vickers hardness of 600 HV or more.

4. The method for producing the electroless Ni—P plating film according to claim 3, wherein the partial initial make-up of an electrolytic bath in step 1 is performed by mixing an unused new solution and an old solution having been used for the electroless plating treatment at a ratio of 50% by mass to 80% by mass of the new solution and 20% by mass to 50% by mass of the old solution when a total of the new solution and the old solution is 100% by mass.
